(19) United States
(12) Patent Application Publication
(10) Pub. No.: US 2006/0161502 A1
(43) Pub. Date: Jul. 20, 2006

(54) System and method for secure and convenient handling of cryptographic binding state information

(75) Inventors: Julian A. Cerruti, San Jose, CA (US); Matthew F. Rutkowski, Pfugerville, TX (US)

Correspondence Address: JANIS E. CLEMENTS, 3112 LOMITA DRIVE, AUSTIN, TX, 78738, US

(73) Assignee: International Business Machines Corporation

(21) Appl. No.: 11/037,766

(22) Filed: Jan. 18, 2005

(51) Int. Cl. G06F 17/60

(52) U.S. Cl. 705/71

(57) ABSTRACT

A common mechanism that can be used in content encryption applications for binding content to a specific receiver, container or communication channel to separate application specific work from the cryptographic details, regardless of the binding scheme being used. This mechanism includes the definition of a secure binding state object which holds and manipulates all the keys that comprise the most sensitive information in any such a system. This information is fully encapsulated in the binding state object and is not accessible from outside the object, making the application less vulnerable to external attacks. The present invention allows applications to be changed quickly from one encryption scheme to another because they all use the same mechanism with only a difference in encryption calculation. Also, components implementing the proposed mechanism grow more stable over time as a result of reuse in multiple applications.

### CROSS-REFERENCE

Copending Application (Attorney Docket No. AUS920040932US1), Ser. No. 11/011,241, Cerruti et al, assigned to common assignee, filed Dec. 14, 2004. This reference is hereby incorporated by reference.

### TECHNICAL FIELD

The present invention relates to data encryption, and particularly the encryption and decryption of content wherein cryptographic binding state information is handled in a secure and convenient manner.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is Internet related distribution of documents. The Web or Internet, which had quietly existed for over a generation as a loose academic and government data distribution facility, reached, “critical mass” and commenced a period of phenomenal expansion. With this expansion, businesses and consumers have direct access to all matter of documents and media through the Internet.

With the advent of consumer digital technology, content such as music and movies are no longer bound to the physical media that carry them. Advances in consumer digital technology present new challenges to content owners such as record labels, studios, distribution networks, and artists who want to protect their intellectual property from unauthorized reproduction and distribution. Recent advances in broadcast encryption offer an efficient alternative to more traditional solutions based on public key cryptography. In comparison with public key methods, broadcast encryption requires orders of magnitude less computational overhead in compliant devices. In addition, broadcast encryption protocols are one-way, not requiring any low-level handshakes, which tend to weaken the security of copy protection schemes. However, by eliminating two-way communications, the potentially expensive return channel on a receiver may be eliminated, lowering overhead costs for device manufacturers and users.

IBM has developed a content protection system based on broadcast encryption called eXtensible Content Protection, referred to as “xCP.” xCP supports a trusted domain called a ‘cluster’ that groups together a number of compliant devices. Content can freely move among these devices, but it is useless to devices that are outside the cluster. Other examples of broadcast encryption applications include Content Protection for Recordable Media (CPRM) media, Content Protection for Pre-Recorded Media (CPPM) media, and Advanced Access Content System (AACS) next-generation media.

Broadcast encryption schemes bind a piece of content to a particular entity, such as a piece of media (e.g. a compact disk or DVD), a server, or a user. Broadcast encryption binds the content by using a media key block (also known as a key management block KMB or session key block) that allows compliant devices to calculate a cryptographic key (the media or management key) using their internal device keys while preventing circumvention (non-compliant) devices from doing the same. One example of a binding scheme is binding to a specific receiver in standard PKI applications wherein content is encrypted with a session key, which is then encrypted with a receiver's public key. The content can only be retrieved with the receiver's private key. Another example of a binding scheme is binding to a specific media in CPRM and AACS Media wherein content is encrypted with a title key, which is then encrypted with a key resulting from a one-way function of a media identifier and a media key (calculated from the media key block described above). A third example of a binding scheme is binding to a specific user, as in xCP Cluster Protocol, wherein content is encrypted with a title key, which is then encrypted with a key resulting from a one-way function of the user's cluster authorization table and binding ID and the user's current management key (calculated from the user's current media key block).

Broadcast encryption does not require authentication of a device and can be implemented with symmetric encryption, allowing it to be much more efficient than public key cryptography. After calculating a media key by processing the media key block (KMB), the scheme uses the media key to bind the content to an entity with a binding identifier, resulting in the binding key. An indirection step occurs when a title key is then chosen and encrypted or decrypted with the binding key, resulting in an encrypted title key or an encrypted indirected key. The content itself may then be encrypted with the title key and the encrypted content may be stored with the encrypted title key. A compliant device that receives the encrypted content and the encrypted title key may use the same KMB and the binding identifier to decrypt the encrypted title key and then to use that title key to decrypt the content. The compliant device first must reproduce the binding key using the KMB, the binding identifier and its device keys, and then decrypt the title key from the encrypted title key using the binding key. Once the compliant device has the title key, it may decrypt the content itself. A circumvention device will not have device keys that can be used to process the KMB and thus will not be able to reproduce the binding key or be able to decrypt the content. Also, if the content has been copied to a different entity with a different identifier by a non-compliant device, the compliant device with valid device keys will not be able to calculate the correct binding key because the binding identifier is different than the original one.

Under prior art systems, all content would be encrypted with a title key which would itself be encrypted with the binding key. Any device attempting to access a piece of content would have to decrypt the content beforehand. To do so, the device would first determine the media key from the KMB and then use the media key in conjunction with the binding identifier and the authorization table to recover the binding key. The device may then use the binding key to recover the title key from the encrypted title key, and then use the title key to decrypt the encrypted content. Because the title key is encrypted with the binding key, any changes to the binding key necessitate re-encrypting each title key with the new binding key.

This approach can lead to exposure of the title key if the application program in the device is compromised. Since the decryption operation exposes the title key, there is a risk that the title key could be exposed by that program. The current approach suffers from the technical problem of requiring specific application program code for each level of encryption or decryption to be performed. The present invention is directed to solving this problem by providing a trusted cryptography object that can securely encrypt or decrypt keys or content without exposing secret keys. A common trusted cryptography object can recursively encrypt keys using additional information, such as cluster ids, device keys, etc to create a binding key that binds the content to a specific cluster or device. The present invention allows encrypted content to be decrypted and played by a client device without exposing the title key outside of the trusted cryptography object. The common encryption mechanism of the present invention simplifies the development of applications that use this type of encryption scheme, resulting in less timely and less costly encryption of applications. The present invention comprises a single binding calculation object (the trusted cryptography object) in which a context key, indirection keys, and instance secret keys are kept. Since the present invention does not allow a user access to the single binding calculation object in which sensitive secrets are always kept, the present invention is more secure than the prior art. The problems described above may also occur in Advanced Access Content Systems (AACS) and 4C Entity LLC's Content Protection System Architecture (CPSA) recordable media where several files may be stored and new KMBs may be introduced into the system.

Therefore, there is a need for an effective and efficient system of encrypting and decrypting content on a cryptographic system, and particularly for the secure and convenient handling of cryptographic binding state information.

### SUMMARY OF THE PRESENT INVENTION

The present invention provides a solution to the previously recited problems by a system, method and related computer program for encrypting or decrypting one or more content files using a binding calculation object. More particularly, the present invention provides a means for defining a binding calculation object, and calculating a first encryption key in the binding calculation object using context information, the first encryption key becoming a current encryption key. The present invention allows zero, one, or more levels of indirection to be added to or removed from the current encryption key. A user can provide additional information for use in the indirection step calculation. Using the present invention, a piece of content is encrypted or decrypted using the current encryption key. At a later time, a user can verify the integrity of such additional information when repeating the indirection step calculation. The encryption entity can detect and refuse an attempt to decrypt and expose an encrypted indirected key by blocking access to a decrypted indirected key.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a line drawing of an exemplary network architecture in which methods and systems according to embodiments of the present invention may be implemented;

FIG. 2 is a generalized view of a system that may be used in the practice of the present invention;

FIG. 3 is an illustrative flowchart describing setting up of the functions for secure and convenient handling of cryptographic binding state information of the present invention; and

FIG. 4 is a flowchart of an illustrative run of the program set up according to FIG. 3.

### DETAILED DESCRIPTION OF THE PREFERRED EMBODIMENT

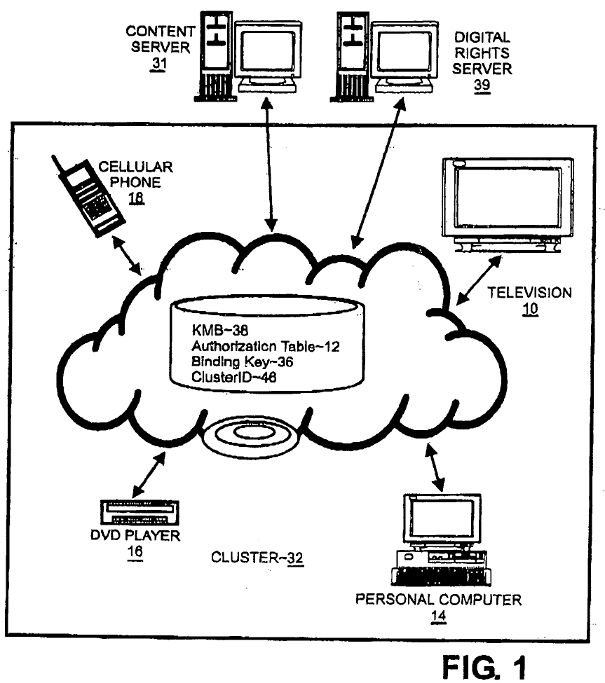

Referring to FIG. 1, a line drawing of an exemplary network architecture is shown in which methods and systems according to embodiments of the present invention may be implemented. While the present invention is operable with various binding schemes, such as binding to a specific receiver in standard PKI applications, binding to a specific media in CPRM and AACS Media, FIG. 1 shows the binding scheme wherein the binding is to a specific user's content in xCP Cluster Protocol. The network of FIG. 1 includes an xCP compliant network cluster 32 that includes several xCP compliant network devices including a cellular telephone 18, a television 10, a DVD player 16, and a personal computer 14. The network may be any type of wired or wireless network, such as Local Area Network (LANS) or Wide Area Networks (WANS). Content may be any data deliverable from a source to a recipient and may be in the form of files such as an audio data file, a video data file, a media data file, a streaming media file, an application file, a text file, or a graphic. An encryption system allows receiving devices within the home network to freely share and utilize encrypted content between them while preventing non-compliant devices from decrypting the encrypted content. A receiving device may optionally be able to record content onto a recorded device for use outside the home network.

The network cluster supports a key management block 38 for the cluster, an authorization table 12 that identifies all the devices currently authorized to join in the cluster, a binding key 36 for the cluster, and a cluster ID 46. The key management block 38 is a data structure containing an encryption of a management key with every compliant device key. That is, the key management block contains a multiplicity of encrypted instances of a management key, one for every device key in the set of device keys for a device. The binding key 36 for the cluster is calculated as a cryptographic one-way function of a management key and a cryptographic hash of a cluster ID and a unique data token for the cluster. The management key for the cluster is calculated from the key management block 38 and device keys.

The network of FIG. 1 includes a content server 31 that is capable of encrypting content with title keys provided to it by content providers, content owners, or a legal licensing authority. Content server 31 is also capable of calculating a binding key for a cluster, given enough information about the cluster, and using the binding key 36 to encrypt a title key and package it with encrypted contents. More particularly, content server 31 may control broadcast encryption of content for a network cluster 32 from outside the cluster by receiving from a network device in the cluster a key management block 38 for the cluster 32, a unique data token for the cluster 32, and an encrypted cluster ID. The content server is capable of using the key management block 38 for the cluster 32, the unique data token for the cluster 32, and the encrypted cluster ID to calculate the binding key for the cluster.

The network of FIG. 1 further includes a digital rights server 39 that is capable of storing rights objects that define rights for the broadcast encryption content. In addition, a digital rights server 39 is also capable of calculating a binding key for a cluster, given enough information about the cluster, and using the binding key to encrypt a title key and insert it into a rights object. More particularly, if a third party DRM solution exists, the present invention is compatible with said third party DRM solution to control broadcast encryption of content for a network cluster 32 from outside the cluster by encrypting a title key with a binding key 36, and inserting the encrypted title key into the rights object. At this point, an external check could be made to the third party DRM solution prior to making content available from a participating device. If a DRM solution is present, access is granted or denied based upon unique identification of encrypted content from the requesting device. A digital rights server may be capable of using a key management block 38 for the cluster 32, a unique data token for the cluster 32, and an encrypted cluster ID to calculate a binding key for the cluster.

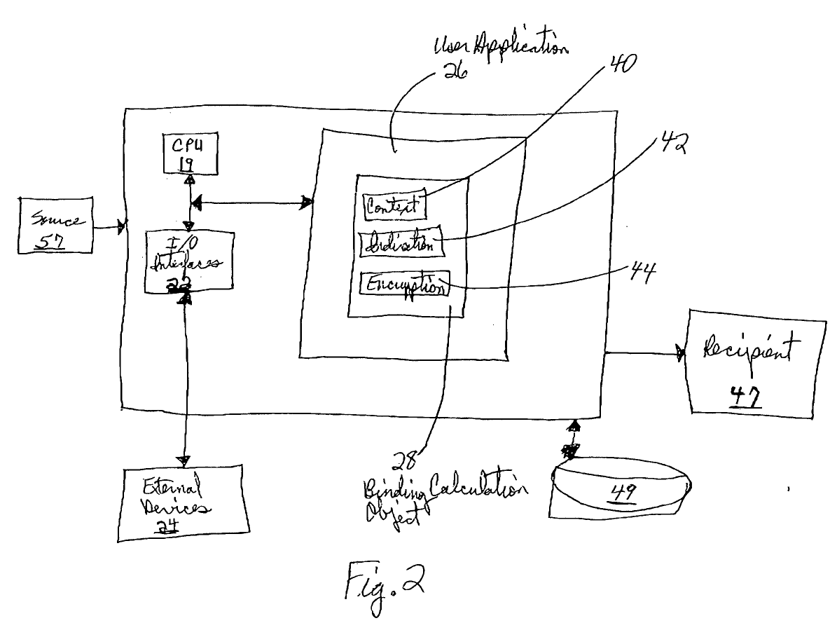

A generalized diagram of a cryptographic system that may be used in the practice of the present invention is shown in FIG. 2. The cryptographic system may be any combination of hardware and/or software that may perform one or more of such tasks as encrypting or decrypting, and attaching a key to content. A typical cryptographic system may be a general purpose computer with a computer program that, when loaded and executed, carries out the methods described herein. Alternatively, cryptographic system may be a specific use computer system containing specialized hardware for carrying out one or more of the functional tasks of the cryptographic system. A specific use computer system may be part of a receiving device, for example, such as an encryption/decryption module associated with a DVD player. Cryptographic system may include one or more central processing units (CPUs 19), an input/output (I/O) interface 22, a user application 26 that includes a binding calculation object 28 wherein a context key 40, indirection key(s) 42, and encryption key 44 are found, external devices 24, and a database 49.

Cryptographic system may also be in communication with a source 57 or a recipient 47. Source 57 may be the source of any content to be encrypted or decrypted or any entity capable of sending transmissions, such as a content owner, a content service provider, or a receiver in a home network. Information received from a source 57 may include any type of information, such as encrypted content, content, content usage conditions, a KMB, encrypted title keys, or binding identifiers. Similarly, a recipient 47 may be any entity capable of receiving transmissions or that is a destination for any encrypted content or other information, such as a receiver in a home network.

CPU 19 may include a single processing unit or may be distributed across one or more processing units in one or more locations, such as on a client and server or a multi-processor system. I/O interface 22 may include any system for exchanging information with an external source. External devices 24 may include any known type of external device, such as speakers, a video display, a keyboard to other user input device, or a printer. Database 49 may provide storage for information used to facilitate performance of the disclosed embodiment. Database 49 may include one or more storage devices, such as a magnetic disk drive or optional disk drive.

User application 26 may include components of application specific information, such as media ID, or authorization table. Binding calculation object 28 may include a context key 40 that is set up via a user's specific information, one or more indirection keys 42, and a final encryption key 44 used to encrypt content. The binding calculation object 28 can be reused in several various applications and is a standard defined mechanism. This standard defined mechanism can be used to create trusted entities that handle a state of a binding transaction for an application. Secret information, such as title keys, media keys, or session keys, can be kept inside these trusted entities (binding calculation objects) decreasing the security risks of transmitting sensitive information in application components. Specific measures can be taken to detect and prevent decryption of title keys outside of the trusted entities.

The binding calculation object or trusted cryptography object 28 can be implemented as a trusted software component that executes in a trusted operating system environment. For example, a computer system could be supplied with a trusted Java Virtual Machine (Java is a trademark of Sun Microsystems, Inc.) whose execution options are known and controlled by the system owner. In the alternative, binding calculation object 28 can be embodied in a read only memory device or application specific hardware device to ensure that no compromising operations can be performed. The advantage is that the decrypted secret information such as the title key is always maintained in the binding object 28 with external access blocked and thus cannot be compromised.

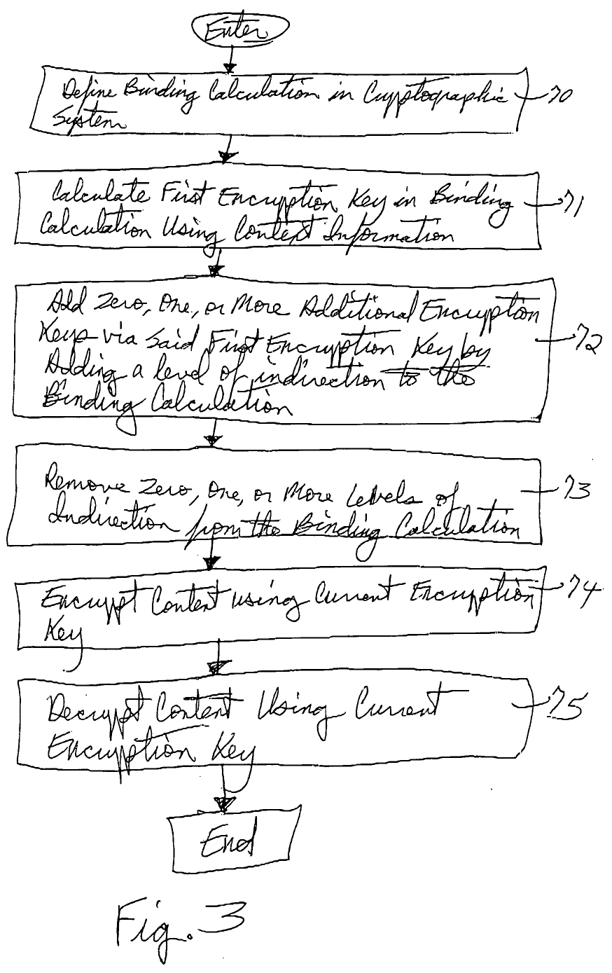

FIG. 3 is a flowchart showing the development of a process according to the present invention for secure and convenient handling of cryptographic binding state information. A binding calculation object is defined in a cryptographic system for delivering encrypted broadcast content to authorized devices, step 70. A first encryption key is calculated in the binding calculation using context information, step 71. Add zero, one, or more additional encryption keys via said first encryption key by adding a level indirection to the binding calculation object, step 72. A level of indirection can be added to the binding calculation by requesting the binding calculation object to choose a random indirected key, encrypt said random indirected key with the current key and then replace the current encrypted key with the indirected key. The resulting encrypted indirection key is delivered to the user. Alternatively, a level of indirection can also be added to the binding calculation object by specifying an encrypted indirection key to the binding calculation object by the user and requesting the binding calculation object to decrypt said encrypted indirected key with the current encryption key, and replacing the current encryption key with the indirected key. Remove zero, one, or more levels of indirection, step 73. The previous current encryption key must be set up as the current encryption key if an indirected step is removed. A current encryption key is used to encrypt content, step 74. A current encryption key is used to decrypt content, step 75. Said current encryption key can be a first encryption key set up in the binding calculation object using context information. The present invention includes means for a user to provide additional information for use in the indirection step calculation that occurs when an additional encryption key is set up. The integrity of said additional information can be verified when repeating the indirection step calculation. Means are provided for decrypting wherein a user's access to a decrypted indirect key is blocked.

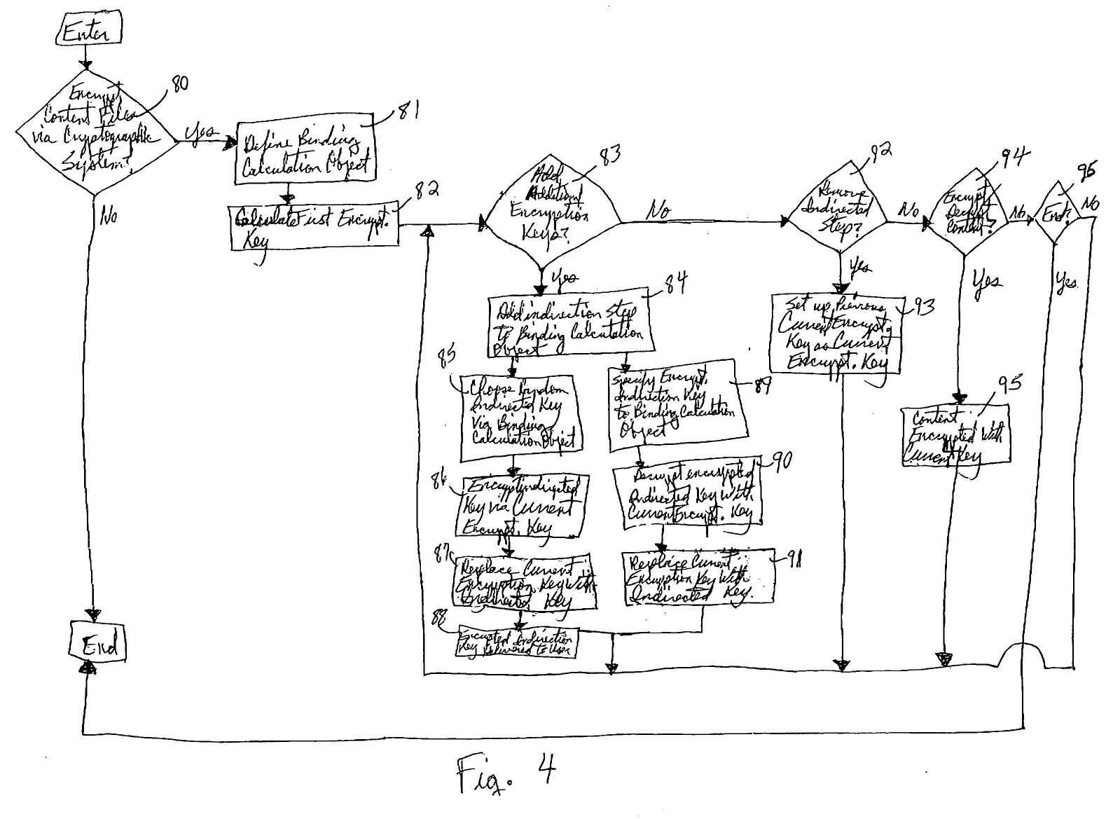

A simplified run of the process set up in FIG. 3 will now be described in with respect to the flowchart of FIG. 4. First, a determination is made as to whether to encrypt or decrypt content files using the cryptographic system, step 80. If No, the process ends. If Yes, a binding calculation object is defined, step 81. Then a first encryption key is calculated using context information, step 82. A determination is made as to whether to set up an add levels of indirection, i.e. adding additional encryption key using said first encryption key, step 83. If Yes, a level of indirection or indirection step is added to the binding calculation object, step 84. An indirection step can be added to the binding calculation by requesting the binding calculation object to choose a random indirected key, step 85, then encrypt the indirected key using the current encryption key, step 86, and replace current encryption key with said indirected key, step 87. The encrypted indirection key is delivered to the user, step 88. An indirection step can also be added to the binding calculation object by specifying encrypted indirection key to binding calculation object, step 89, and requesting the binding calculation object to decrypt the encrypted indirected key with a current encryption key, step 90, and replace current encryption key with said indirected key, step 91. The process continues back to step 83, wherein a user has an opportunity to set up an additional encryption key. If no additional encryption keys are set up, a determination is made whether to remove an indirected step, step 92. If Yes, the previous current encryption key is set up as the current encryption key, step 93. The process continues back to step 83, wherein a user has an opportunity to set up an additional encryption key. If no indirected step is removed, a determination is made as to whether to encrypt or decrypt content, step 94. If Yes, content is encrypted or decrypted with the current encryption key, step 95, and the process continues back to step 83, wherein a user has an opportunity to set up an additional encryption key. If the content is not encrypted, a determination is made as to whether to end the process, step 96. If No, the process continues back to step 83, wherein a user has an opportunity to set up an additional encryption key. If Yes, the process ends.

The present invention is described in this specification in terms of methods for the secure and convenient handling of cryptographic binding state information. One skilled in the art should appreciate that the processes controlling the present invention are capable of being distributed in the form of computer readable media of a variety of forms. The invention may also be embodied in a computer program product, such as a diskette or other recording medium, for use with any suitable data processing system. Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Although certain preferred embodiments have been shown and described, it will be understood that many changes and modifications may be made therein without departing from the scope and intent of the appended claims.

1. A cryptographic system for encrypting or decrypting one or more content files using a binding calculation object comprising:
means for defining a binding calculation object;
means for calculating a first encryption key in the binding calculation object using context information, the first encryption key becoming a current encryption key;
means for adding zero, one, or more levels of indirection to the current encryption key;
means for removing zero, one, or more levels of indirection from the current encryption key;
means for encrypting a piece of content using the current encryption key and
means for decrypting a piece of content using the current encryption key.

2. The cryptographic system of claim 1 wherein adding a level of indirection comprises:
means for the binding calculation object to choose a random indirected key;
means for encrypting said indirected key with the current encryption key;
means for replacing the current encryption key with said indirected key; and
means for delivering the encrypted indirected key to a user.

3. The cryptographic system of claim 1 wherein adding a level of indirection further comprises:
means for specifying an encrypted indirected key to the binding calculation object;
means for decrypting said encrypted indirected key with the current encryption key; and
means for replacing the current encryption key with said indirected key.

4. The cryptographic system of claim 2 further comprising:
means for receiving additional information for use in adding or removing levels of indirection; and
means for using the additional information to verify integrity of provided information when repeating a level of indirection calculation.

5. The cryptographic system of claim 3 further comprising:
means for receiving additional information for use in adding or removing a level of indirection; and
means for using the additional information to verify integrity of provided information when repeating a level of indirection calculation.

6. The cryptographic system of claim 1 wherein the means for decrypting blocks user access to a decrypted indirect key.

7. A cryptographic method for encrypting or decrypting one or more content files using a binding calculation object including the steps of:
creating a binding calculation object;
generating a first encryption key in the binding calculation object from context information, the first encryption key becoming a current encryption key;
adding zero, one, or more levels of indirection to the current encryption key;
removing zero, one, or more levels of indirection to the current encryption key;
encrypting a piece of content using the current encryption key; or
decrypting a piece of content using the current encryption key.

8. The method of claim 7 wherein adding the level of indirection comprises the steps of:
choosing a random indirected key by the binding calculation object;
encrypting said indirected key with a current encryption key;
replacing current encryption key with said indirected key; and
delivering the encrypted indirected key to a user.

9. The method of claim 7 wherein adding the level of indirection further comprises the steps of:
specifying an encrypted indirected key to the binding calculation object;
decrypting said encrypted indirected key with the current encryption key; and
replacing current encryption key with said indirected key.

10. The method of claim 8 further comprising the steps of:
providing by a user additional information for use in adding or removing a level of indirection; and
using the additional information to verify integrity of provided information when repeating the level of indirection calculation.

11. The method of claim 9 further comprising the steps of:
providing by a user additional information for use in adding or removing a level of indirection calculation; and
using the additional information to verify integrity of provided information when repeating the level of indirection calculation.

12. The method of claim 7 wherein the means for decrypting blocks user access to a decrypted indirect key.

13. A computer program having code recorded on a computer readable medium for fast communication with a symbol linked object based system for encrypting or decrypting one or more content files in a cryptographic system using a binding calculation object comprising:
means for defining a binding calculation object;
means for calculating a first encryption key in the binding calculation object using context information, the first encryption key becoming a current encryption key;
means for adding zero, one, or more levels of indirection to the current encryption key;
means for removing zero, one, or more levels of indirection from the current encryption key;
means for encrypting a piece of content using the current encryption key and
means for decrypting a piece of content using the current encryption key.

14. The computer program of claim 13 wherein adding the level of indirection comprises:
means for the binding calculation object to choose a random indirected key;
means for encrypting said indirected key with a current encryption key;
means for replacing current encryption key with said indirected key; and
means for delivering the encrypted indirected key to a user.

15. The computer program of claim 13 wherein adding the level of indirection further comprises:
means for specifying an encrypted indirected key to the binding calculation object;
means for decrypting said encrypted indirected key with the current encryption key; and
means for replacing current encryption key with said indirected key.

16. The computer program of claim 13 further comprising:
means for providing by a user additional information for use in adding or removing a level of indirection; and
means for using the additional information to verify integrity of provided information when repeating the level of indirection calculation.

17. The computer program of claim 14 further comprising:
means for providing by a user additional information for use in adding or removing a level of indirection calculation; and
means for using the additional information to verify integrity of provided information when repeating the level of indirection calculation.

18. The computer program of claim 13 wherein means for decrypting blocks user access to a decrypted indirect key.
